(19) United States
(12) Patent Application Publication
(10) Pub. No.: US 2025/0291273 A1
(43) Pub. Date: Sep. 18, 2025

(54) IMAGE FORMING APPARATUS

(71) Applicant: KYOCERA Document Solutions Inc., Osaka (JP)

(72) Inventor: Minori Yamamoto, Osaka (JP)

(21) Appl. No.: 19/077,411

(22) Filed: Mar. 12, 2025

(30) Foreign Application Priority Data
Mar. 15, 2024 (JP) 2024-041182

(51) Int. Cl. G03G 15/08; G03G 15/01

(52) U.S. Cl. CPC G03G 15/0863; G03G 15/0121; G03G 15/0189; G03G 15/0867

(57) ABSTRACT

An image forming apparatus includes two mounting units and a wireless reader. On each of the two mounting units, a developer cartridge that contains a developer that is used for forming an image is mountable, and the two mounting units are provided side by side in a first direction. The wireless reader is provided corresponding to each of the mounting units and reads information from a memory unit provided in the developer cartridge that is mounted on the mounting unit by wireless communication. The two wireless readers corresponding to the two mounting units are provided at different positions in a second direction orthogonal to the first direction and longitudinal directions of the mounting units.

### INCORPORATION BY REFERENCE

This application is based upon and claims the benefit of priority from the corresponding Japanese Patent Application No. 2024-041182 filed on Mar. 15, 2024, the entire contents of which are incorporated herein by reference.

### FIELD

The present disclosure relates to an image forming apparatus.

### BACKGROUND

In an image forming apparatus such as a printer or a copying machine, a developer cartridge containing a developer such as toner is attachable and detachable to/from the image forming apparatus. Moreover, in the image forming apparatus, a wireless reader that wirelessly reads information from a memory unit provided in the developer cartridge attached to the image forming apparatus is sometimes provided. Moreover, in the image forming apparatus, two mounting units on each of which two developer cartridges corresponding to a single-color developer are mountable may be provided side by side in an up-and-down direction in the image forming apparatus. In such a configuration, a wireless reader that wirelessly reads information from a memory unit provided in the developer cartridge mounted on the mounting unit may be provided for each mounting unit.

### SUMMARY

An image forming apparatus according to an aspect of the present disclosure includes two mounting units and a wireless reader. On each of the two mounting units, a developer cartridge that contains a developer that is used for forming an image is mountable, and the two mounting units are provided side by side in a first direction. The wireless reader is provided corresponding to each of the mounting units and reads information from a memory unit provided in the developer cartridge that is mounted on the mounting unit by wireless communication. The two wireless readers corresponding to the two mounting units are provided at different positions in a second direction orthogonal to the first direction and longitudinal directions of the mounting units.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a configuration diagram of an image forming apparatus according to an embodiment.

FIG. 2 is a block diagram showing a configuration of a control device in the image forming apparatus according to the embodiment.

FIG. 3 is a configuration diagram of a toner supply unit in the image forming apparatus according to the embodiment.

### DETAILED DESCRIPTION

Embodiments of the present disclosure will be described below with reference to the drawings. Note that the following embodiments are merely examples embodying the present disclosure and do not limit the technical scope of the present disclosure.

### Configuration of Image Forming Apparatus 10

An image forming apparatus 10 according to this embodiment is capable of performing print processing of forming an image on a sheet 9. The image forming apparatus 10 is a printer. Note that the image forming apparatus 10 may be a copying machine, a facsimile apparatus, a multifunction peripheral, or other apparatus.

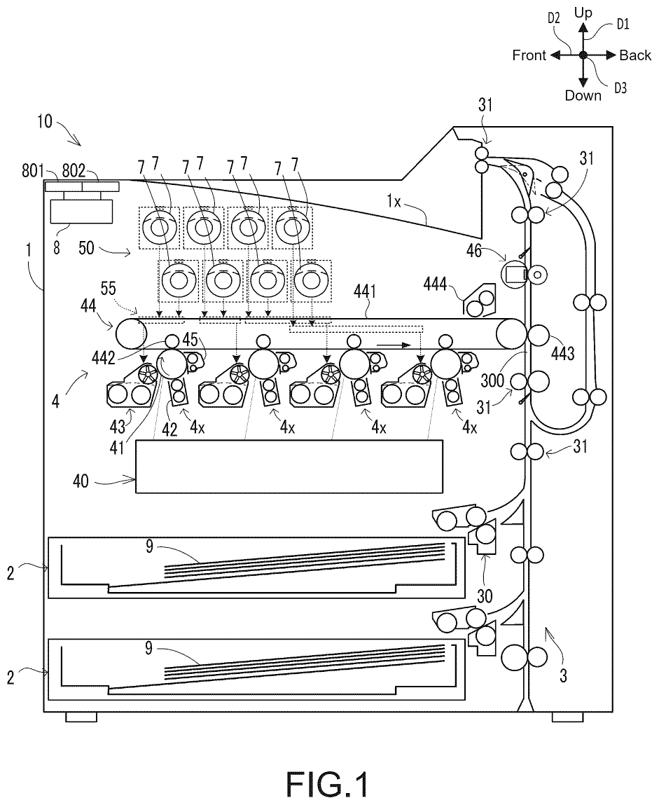

Note that for the sake of description, the vertical direction is defined as an up-and-down direction D1 in an installed state in which the image forming apparatus 10 can be used (state shown in FIG. 1). Moreover, a front-and-back direction D2 is defined, assuming that a left surface of the image forming apparatus 10 in FIG. 1 is front (front surface). Moreover, a left-and-right direction D3 is defined on the basis of the front of the image forming apparatus 10 in the installed state.

As shown in FIG. 1, the image forming apparatus 10 includes a main casing 1, a sheet housing unit 2, a conveying device 3, a print device 4, a toner supply unit 50, a control device 8, an operation device 801, and a display device 802.

The operation device 801 is a device for receiving an operation from a person. For example, the operation device 801 includes one or both of a touch panel and an operation button. The display device 802 is a liquid-crystal display or other device that is capable of displaying various types of information.

The conveying device 3 includes a conveying path 300, a sheet feeding mechanism 30, and a plurality of conveying roller pairs 31. The sheet feeding mechanism 30 sends sheets 9 housed in the sheet housing unit 2 to the conveying path 300 one by one. The plurality of conveying roller pairs 31 conveys the sheet 9 along the conveying path 300.

The print device 4 performs the print processing on the sheet 9, using toner as a developer. Specifically, the print device 4 performs the print processing by an electrophotographic method. Note that in other embodiments, the image forming apparatus 10 may be an inkjet-type image forming apparatus that forms an image on the sheet 9, using ink as a developer, not limited to the electrophotographic method.

The print device 4 includes an exposure device 40, one or more image forming units 4x, a transfer device 44, and a fixing device 46. The print device 4 shown in FIG. 1 is a tandem-type color print device. In this case, the print device 4 includes a plurality of image forming units 4x corresponding to a plurality of developing colors. Note that in other embodiments, not limited to the color printer, the image forming apparatus 10 may be a monochrome printer including only an image forming unit 4x corresponding to a single color.

In the example shown in FIG. 1, the print device 4 includes four image forming units 4x corresponding to developing colors, yellow (Y), magenta (M), cyan (C), and black (Bk).

Each of the image forming units 4x includes a photoreceptor 41, a charging device 42, a development device 43, and a first cleaner 45. The photoreceptors 41 rotate and the charging devices 42 charge the surfaces of the photoreceptors 41.

The exposure device 40 scans the charged surfaces of the photoreceptors 41 with laser light based on image data, thereby writing electrostatic latent images on the surfaces of the photoreceptors 41. The development devices 43 feed toner to the surfaces of the photoreceptors 41, thereby developing the electrostatic latent images as toner images.

The transfer device 44 transfers the toner images on the surfaces of the photoreceptors 41 to a sheet 9 conveyed along the conveying path 300. In the tandem-type print device 4, the transfer device 44 includes an intermediate transfer belt 441, a plurality of primary transfer devices 442, a secondary transfer device 443, and a second cleaner 444. The plurality of primary transfer devices 442 is provided, corresponding to the plurality of image forming units 4x.

The intermediate transfer belt 441 rotates in a state in which a part thereof is along the plurality of image forming units 4x. The plurality of primary transfer devices 442 transfers the toner images on the surfaces of the photoreceptors 41 of the plurality of image forming units 4x to the surface of the intermediate transfer belt 441. Accordingly, a color toner image in which the toner images in the plurality of colors are combined is formed on the surface of the intermediate transfer belt 441.

The secondary transfer device 443 transfers the color toner image on the surface of the intermediate transfer belt 441 to the sheet 9. The fixing device 46 heats and presses the color toner image on the sheet 9, thereby fixing the color toner image to the sheet 9. Note that the sheet 9 is a sheet-like image forming medium such as paper.

The toner supply unit 50 supplies toner to the development devices 43 of the plurality of image forming units 4x in the print device 4. The toner supply unit 50 includes a plurality of mounting units 5. Each of the mounting units 5 is a unit to which a developer cartridge 7 that contains toner used as a developer is removably mounted.

The toner supply unit 50 supplies the toner from the plurality of developer cartridges 7 mounted on the plurality of mounting units 5 to the development devices 43 of the plurality of image forming units 4x for each developing color. The toner is an example of a developer that is used for forming an image on a sheet 9 in the image forming apparatus 10.

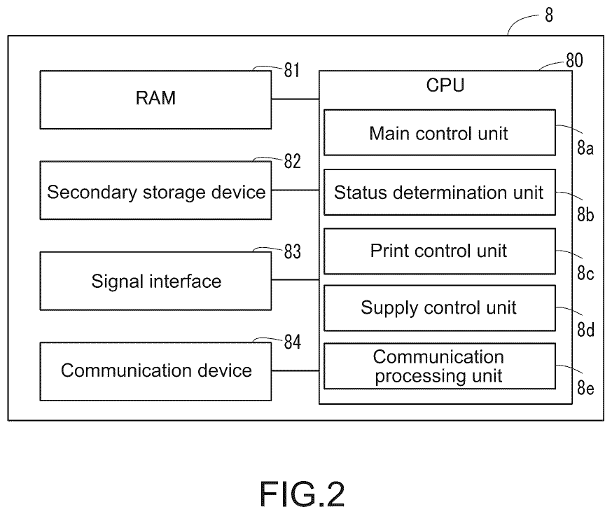

The control device 8 controls various electric devices provided in the image forming apparatus 10. As shown in FIG. 2, the control device 8 is a computer including a central processing unit (CPU) 80, a random access memory (RAM) 81, a secondary storage device 82, a signal interface 83, a communication device 84, and other device.

The CPU 80 is a processor that performs various types of control and data processing by executing a computer program. The RAM 81 temporarily stores the computer program executed by the CPU 80 and various types of data.

The secondary storage device 82 is a computer-readable nonvolatile storage device. The secondary storage device 82 stores the computer program executed by the CPU 80 and the various types of data. For example, one or both of a flash memory and a hard disk drive is employed as the secondary storage device 82.

The signal interface 83 converts detection signals of various sensors to digital detection data. The detection data is transmitted to the CPU 80. The communication device 84 communicates with a plurality of external devices including one or more host devices via a network. The CPU 80 communicates with each of the external devices via the communication device 84. The host devices are information processing devices like personal computers that requests the print processing from the image forming apparatus 10.

The CPU 80 includes a plurality of processing modules that are realized by performing an image forming method including various steps in accordance with the computer program. The plurality of processing modules includes a main control unit 8a, a status determination unit 8b, a print control unit 8c, a supply control unit 8d, a communication processing unit 8e, and the like (see FIG. 2).

The main control unit 8a performs processing of receiving various requests and control to cause other modules to perform processing according to the requests. For example, the main control unit 8a receives a print request via the operation device 801 or the communication device 84. In addition, the main control unit 8a causes the print control unit 8c to perform print processing according to the print request.

The status determination unit 8b determines various statuses of the image forming apparatus 10 in accordance with detection statuses of the various sensors in the image forming apparatus 10 and operation statuses of various devices.

The print control unit 8c controls the conveying device 3 and the print device 4. The print control unit 8c causes the print device 4 to perform the print processing while causing the conveying device 3 to convey the sheet 9.

The supply control unit 8d controls the supply of the toner from the toner supply unit 50 to the print device 4 by controlling the toner supply unit 50.

The communication processing unit 8e reads various types of information from memory units 71 to be described later, which are provided in the developer cartridges 7, by using wireless readers 6 to be described later, which are provided in the toner supply unit 50. The information read by the communication processing unit 8e is used for various types of processing in the main control unit 8a, the print control unit 8c, the supply control unit 8d, and the like.

### Toner Supply Unit 50

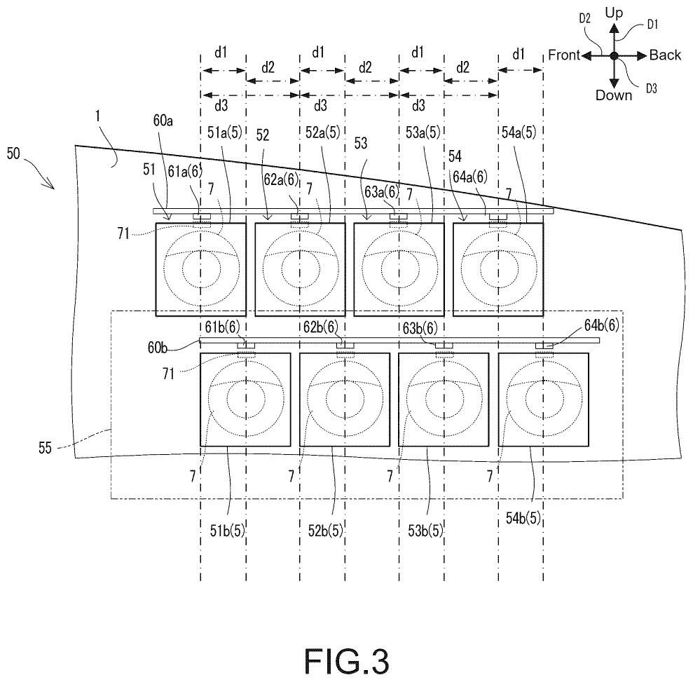

Hereinafter, referring to FIG. 3, the toner supply unit 50 will be described in detail. Note that FIG. 3 is a schematic view showing main parts of the toner supply unit 50 in the image forming apparatus 10.

As shown in FIG. 3, the toner supply unit 50 includes four mounting unit sets 51 to 54, a supply mechanism 55, and two wireless reading boards 60a and 60b.

The mounting unit sets 51 to 54 are arranged side by side in the front-and-back direction D2 in the toner supply unit 50. The mounting unit sets 51, 52, 53, and 54 correspond to toner in four colors, yellow, magenta, cyan, and black, respectively. The mounting unit set 51 to 54 includes two mounting units 5 for each color corresponding to the mounting unit set 51 to 54. On each of the mounting units 5, the developer cartridge 7 containing the toner in color corresponding to the mounting unit 5 is mounted.

Specifically, an mounting unit set 51 corresponding to yellow includes mounting units 51a and 51b on which the developer cartridge 7 corresponding to the same color, the yellow toner, is mountable. Moreover, the mounting units 51a and 51b are provided side by side in the up-and-down direction D1 in the image forming apparatus 10. Note that as it will be described later, the mounting units 51a and 51b are different in position in the front-and-back direction D2.

Similarly, an mounting unit set 52 corresponding to magenta includes mounting units 52a and 52b, which are provided side by side in the up-and-down direction D1. An mounting unit set 53 corresponding to cyan includes mounting units 53a and 53b, which are provided side by side in the up-and-down direction D1. An mounting unit set 54 corresponding to black includes mounting units 54a and 54b, which are provided side by side in the up-and-down direction D1.

That is, in the toner supply unit 50, four mounting units 51a to 54a corresponding to the four colors, which are located on the upper side, are provided side by side in the front-and-back direction D2, and four mounting units 51b to 54b corresponding to the four colors, which are located on the lower side, are also provided side by side in the front-and-back direction D2. Although the mounting units 5 corresponding to the same color are provided side by side in the up-and-down direction D1 in this embodiment, the mounting units 5 corresponding to different colors may be provided side by side in the up-and-down direction D1.

In the image forming apparatus 10, regarding each of the four mounting unit sets 51 to 54 corresponding to the four colors, one of the two mounting units 5 is selected as a target mounting unit. Regarding each of the four mounting unit sets 51 to 54, the supply mechanism 55 feeds toner to the development device 43 corresponding to the mounting unit set 51 to 54 from the developer cartridge 7 mounted to the target mounting unit. For example, toner supply paths to the development device 43 from the two mounting units 5 corresponding to the same color may be separately provided or may be structured to merge in the middle.

Note that in the image forming apparatus 10, the supply control unit 8d may be capable of switching between a first mode to use only one developer cartridge 7 with respect to the same color toner and a second mode to use two developer cartridges 7 with respect to the same color toner. For example, in a case where the operation mode of the image forming apparatus 10 is the first mode, the supply control unit 8d selects one mounting unit 5 of the plurality of mounting units 5 corresponding to the same color toner, which has been specified in advance in accordance with a user operation, as the target mounting unit. On the other hand, in a case where the operation mode of the image forming apparatus 10 is the second mode, the supply control unit 8d selects the other mounting unit 5 as the target mounting unit when the determination status of the status determination unit 8b as to a target container changes from a status with toner to a toner empty status.

The wireless communication boards 60a and 60b include a plurality of wireless communication units 6 that reads information from the memory units 71 by wireless communication. Specifically, corresponding to each of the four mounting units 51a to 54a of the mounting unit sets 51 to 54, which are located on the upper side, the wireless communication board 60a is provided across regions above the four mounting units 51a to 54a. The wireless communication board 60a includes four wireless readers 61a to 64a arranged side by side at equal intervals in the front-and-back direction D2. The four wireless readers 61a to 64a are respectively mounted on a lower surface of the wireless communication board 60b to face the memory units 71 provided on the upper surfaces of the developer cartridges 7 when the developer cartridges 7 are mounted on the four mounting units 51a to 54a.

Similarly, corresponding to each of four mounting units 51b to 54b of the mounting unit sets 51 to 54, which are located on the lower side, the wireless communication board 60b is provided across regions above the four mounting units 51b to 54b. The wireless communication board 60b includes four wireless readers 61b to 64b arranged side by side at equal intervals in the front-and-back direction D2. The four wireless readers 61b to 64b are mounted on the lower surface of the wireless communication board 60b to face the memory units 71 provided on the upper surfaces of the developer cartridges 7 when the developer cartridges 7 are mounted on the four mounting units 51b to 54b. That is, the mounting unit sets 51 to 54 corresponding to the four colors are provided with the two wireless readers 6 corresponding to the respective colors.

Note that in this embodiment, the arrangement intervals of the wireless readers 6 on the wireless communication boards 60a and 60b are equal. Accordingly, the wireless communication boards 60a and 60b can be the same components. Alternatively, in other embodiments, the arrangement intervals of the wireless readers 6 on the wireless communication boards 60a and 60b may be different. Moreover, the arrangement intervals of the wireless readers 61a to 64a on the wireless communication board 60a may be different or the arrangement intervals of the wireless readers 61b to 64b on the wireless communication board 60b may be different.

In other embodiments, the arrangement of the components in the toner supply unit 50 may have an opposite vertical relationship. Specifically, the wireless communication board 60a may be provided at a position between the mounting units 51a to 54a and the mounting units 51b to 54b and the wireless communication board 60b may be provided across regions below the mounting units 51b to 54b. In this case, the wireless readers 61a to 64a are mounted on the upper surface of the wireless communication board 60a and the wireless readers 61b to 64b are mounted on the upper surface of the wireless communication board 60b. On the other hand, the memory units 71 are provided on the lower surface for each of the developer cartridges 7.

Note that the wireless readers 61a to 64a may be discretely arranged without being mounted on the same wireless communication board 60a. Similarly, in other embodiments, the wireless readers 61b to 64b may be discretely arranged without being mounted on the same wireless communication board 60a.

Moreover, in the toner supply unit 50, the positions of the wireless readers 61a to 64a in the left-and-right direction D3, which is longitudinal directions of the developer cartridges 7, may be the same or may be different. Similarly, in the toner supply unit 50, the positions of the wireless readers 61b to 64b in the left-and-right direction D3 may be the same or may be different. In addition, the positions of the wireless readers 61a to 64a and the positions of the wireless readers 61b to 64b in the left-and-right direction D3 may be the same or may be different.

The developer cartridges 7 mounted on the mounting units 5 include the memory units 71. In the developer cartridges 7, the memory units 71 are provided at such positions that they face the wireless readers 6 of the mounting units 5 when the developer cartridges 7 are mounted on the mounting units 5.

In this embodiment, as shown in FIG. 3, the memory units 71 of the developer cartridges 7 are arranged in the middle of the developer cartridges 7 in the front-and-back direction D2. Alternatively, in other embodiments, the memory units 71 of the developer cartridges 7 may be arranged at positions different from the middle of the developer cartridges 7 in the front-and-back direction D2. In this case, the wireless readers 6 on the wireless communication boards 60a and 60b are provided at positions to face the positions of the memory units 71 when the developer cartridges 7 are mounted on the mounting units 5.

The memory units 71 are wireless tags including memories for storing specific information related to the developer cartridges 7. Note that the memory units 71 are so-called passive-type memory units and operate by electric power supplied from the wireless readers 6. In general, the memory units 71 are sometimes called radio frequency identification (RFID) tags. The specific information includes information such as individual identification information, manufacturer information, and dates of manufacture of the developer cartridges 7. Moreover, the specific information includes information such as an initial amount of toner contained in the developer cartridges 7, toner types, and toner colors.

In the toner supply unit 50 configured in this manner, the memory units 71 of the developer cartridges 7 and the wireless readers 6 of the mounting units 5 are arranged to face each other when the developer cartridges 7 are mounted on the mounting units 5. Accordingly, the wireless readers 6 are capable of reading information from the memory units 71 provided in the developer cartridges 7 mounted on the mounting units 5 by wireless communication. Moreover, the wireless readers 6 may be capable of writing information on the memory units 71.

By the way, in a case where the two mounting units 5 are provided side by side in the up-and-down direction, the wireless reader 6 corresponding to one mounting unit 5 may erroneously read information from the memory unit 71 of the developer cartridge 7 mounted on the other mounting unit 5, not from the developer cartridge 7 mounted on the mounting unit 5. In this regard, the image forming apparatus 10 is capable of improving the accuracy of reading information from the memory units 71 provided in the two developer cartridges 7 arranged in line.

Specifically, as shown in FIG. 3, in each of the mounting unit sets 51 to 54, the two mounting units 5 corresponding to the same color are provided at different positions in the front-and-back direction D2 orthogonal to both of the up-and-down direction D1 and the left-and-right direction D3, which is the longitudinal directions of the mounting units 5. The two wireless readers 6 corresponding to the same color toner are also provided at different positions in the front-and-back direction D2 orthogonal to both of the up-and-down direction D1 and the left-and-right direction D3, which is the longitudinal directions of the mounting units 5. Note that in this embodiment, the up-and-down direction D1 is an example of a first direction in the present disclosure and the front-and-back direction D2 is an example of a second direction in the present disclosure.

In this regard, for example, as another configuration, the wireless readers 6 corresponding to the two mounting units 5 on which the developer cartridges 7 corresponding to the same color toner are mounted, but they may be provided at the same position in the front-and-back direction D2. However, in this case, the distance between the wireless reader 6 for the mounting unit 5 located on the upper side and the memory unit 71 of the developer cartridge 7 mounted on the mounting unit 5 located on the lower side is the shortest.

On the other hand, in this embodiment, the wireless readers 6 corresponding to the two mounting units 5 on which the developer cartridges 7 corresponding to the same color toner are mounted are provided at different positions in the front-and-back direction D2. Therefore, as compared to the above-mentioned another configuration, the distance between the wireless reader 6 for the mounting unit 5 located on the upper side and the memory unit 71 of the developer cartridge 7 mounted on the mounting unit 5 located on the lower side is longer. Therefore, the possibility in that the wireless reader 6 erroneously reads information from the memory unit 71 for the color different from the color corresponding to the wireless reader 6 lowers.

Specifically, the wireless readers 61a and 61b corresponding to the two mounting units 51a and 51b on which the developer cartridges 7 corresponding to the yellow toner are mounted are provided at different positions in the front-and-back direction D2. Similarly, the wireless readers 62a and 62b on which the developer cartridges 7 corresponding to the magenta toner are mounted are provided at different positions in the front-and-back direction D2. The wireless readers 63a and 63b on which the developer cartridges 7 corresponding to the cyan toner are mounted are also provided at different positions in the front-and-back direction D2. The wireless readers 64a and 64b on which the developer cartridges 7 corresponding to the black toner are mounted are also provided at different positions in the front-and-back direction D2.

An arrangement interval d1 between the two wireless readers 61a and 61b equals the length of the half of the width of the mounting unit 5 in the front-and-back direction D2. Similarly, an arrangement interval d1 between the two wireless readers 62a and 62b equals the length of the half of the width of the mounting unit 5 in the front-and-back direction D2. An arrangement interval d1 between the two wireless readers 63a and 63b equals the length of the half of the width of the mounting unit 5 in the front-and-back direction D2. An arrangement interval d1 between the two wireless readers 64a and 64b equals the length of the half of the width of the mounting unit 5 in the front-and-back direction D2.

In this manner, in this embodiment, the arrangement interval between the two wireless readers 6 corresponding to the two mounting units 5 on which the developer cartridges 7 corresponding to the same color toner are mounted equals the length of the half of the width of the mounting unit 5 in the front-and-back direction D2. Thus, suppression of an increase in the size required for the toner supply unit 50 and improvement of the accuracy of reading information from the memory units 71 by the wireless readers 6 can be achieved with a good balance. Note that in other embodiments, the arrangement interval between the two wireless readers 6 corresponding to the two mounting units 5 on which the developer cartridges 7 corresponding to the same color toner are mounted may equal the length of the half of the width of the developer cartridge 7 in the front-and-back direction D2.

In addition, in the toner supply unit 50, the arrangement interval d1 in the front-and-back direction D2 between the two wireless readers 6 corresponding to the same color toner is shorter than an arrangement interval d3 in the front-and-back direction D2 between the two wireless readers 6 corresponding to different color toners. For example, the arrangement interval d1 between the wireless reader 61a and the wireless reader 61b corresponding to yellow is shorter than the arrangement interval d3 between the wireless reader 61a corresponding to yellow and the wireless reader 62a corresponding to magenta, which are adjacent to each other. Moreover, the arrangement interval d1 between the wireless reader 61a and the wireless reader 61b is shorter than an arrangement interval d3 between the lower wireless reader 61b corresponding to yellow and the upper wireless reader 62a corresponding to magenta. Accordingly, the possibility in that the wireless reader 6 erroneously reads information from the memory unit 71 for the color different from the color corresponding to the wireless reader 6 lowers.

As described above, in the image forming apparatus 10, the wireless readers 61 corresponding to the two mounting units 5 arranged side by side in the up-and-down direction are provided at different positions in the front-and-back direction D2. Therefore, the possibility in that the wireless readers 6 of the two mounting units 5 arranged side by side in the up-and-down direction D1 erroneously read information from a memory unit 71 of the memory units 71 provided in the two developer cartridges 7 mounted on the mounting units 5, which is not intended to be a reading target in the design, can lower. Thus, the accuracy of reading information from the memory units 71 can be improved.

Note that in other embodiments, the developer cartridges 7 mounted on the mounting unit set 54 corresponding to black are larger in the width in the front-and-back direction D2 and are larger in toner capacity than the developer cartridges 7 mounted on the mounting unit sets 51 to 53 for yellow, magenta, and cyan. In this case, the mounting units 54a and 54b of the mounting unit set 54 are also larger in the width in the front-and-back direction D2 than the mounting units 51a to 53a and the mounting units 51b to 53b of the mounting unit sets 51 to 53. Therefore, in this type of image forming apparatus 10, the arrangement interval between the wireless readers 64a and 64b corresponding to the mounting units 54a and 54b corresponding to black may be larger than the arrangement interval d1 corresponding to the other color. Specifically, the arrangement interval between the wireless readers 64a and 64b equals the length of the half of the width of the developer cartridges 7 in the front-and-back direction D2 mounted on the mounting units 54a and 54b in some cases. In these cases, the arrangement intervals of the wireless readers 6 on the wireless communication boards 60a and 60b do not need to be equal. Note that in a case where the developer cartridges 7 mounted on the mounting unit set 54 corresponding to black are larger in the width in the front-and-back direction D2 than the developer cartridges 7 mounted on the mounting unit sets 51 to 53 for yellow, magenta, and cyan, the arrangement intervals of the wireless readers 6 on the wireless communication boards 60a and 60b may be equal intervals.

### Notes of Invention

The outline of the invention extracted from the above-mentioned embodiments will be given below. Note that the configurations and processing functions described in the following notes can be arbitrarily selected and combined.

### Note 1

An image forming apparatus, including:
two mounting units on each of which a developer cartridge that contains a developer that is used for forming an image is mountable, the two mounting units being provided side by side in a first direction; and
a wireless reader that is provided corresponding to each of the mounting units and reads information from a memory unit provided in the developer cartridge that is mounted on the mounting unit by wireless communication, in which
the two wireless readers corresponding to the two mounting units are provided at different positions in a second direction orthogonal to the first direction and longitudinal directions of the mounting units.

### Note 2

The image forming apparatus according to Note 1,
on the two mounting units, the developer cartridges corresponding to the developers in the same color are mounted.

### Note 3

The image forming apparatus according to Note 2, further including
the two mounting units and the two wireless readers corresponding to each of a plurality of colors.

### Note 4

The image forming apparatus according to Note 3, in which
the mounting units corresponding to the plurality of colors are provided side by side in the second direction.

### Note 5

The image forming apparatus according to Note 4, in which
an arrangement interval in the second direction between the two wireless readers corresponding to the developers in the same color are smaller than an arrangement interval in the second direction between two wireless readers corresponding to the developers in different colors.

### Note 6

The image forming apparatus according any of Notes 1 to 5, in which
the arrangement interval in the second direction between the two wireless readers is a length that is a half of a width in the second direction of the developer cartridge or the mounting units.

### Note 7

The image forming apparatus according any of Notes 1 to 6, in which
the two wireless readers are the same in positions in the longitudinal directions.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
two mounting units on each of which a developer cartridge that contains a developer that is used for forming an image is mountable, the two mounting units being provided side by side in a first direction; and
a wireless reader that is provided corresponding to each of the mounting units and reads information from a memory unit provided in the developer cartridge that is mounted on the mounting unit by wireless communication, wherein
the two wireless readers corresponding to the two mounting units are provided at different positions in a second direction orthogonal to the first direction and longitudinal directions of the mounting units.

2. The image forming apparatus according to claim 1, wherein
on the two mounting units, the developer cartridges corresponding to the developers in the same color are mounted.

3. The image forming apparatus according to claim 2, further comprising
the two mounting units and the two wireless readers corresponding to each of a plurality of colors.

4. The image forming apparatus according to claim 3, wherein
the mounting units corresponding to the plurality of colors are provided side by side in the second direction.

5. The image forming apparatus according to claim 4, wherein
an arrangement interval in the second direction between the two wireless readers corresponding to the developers in the same color are smaller than an arrangement interval in the second direction between two wireless readers corresponding to the developers in different colors.

6. The image forming apparatus according to claim 1, wherein
the arrangement interval in the second direction between the two wireless readers is a length that is a half of a width in the second direction of the developer cartridge or the mounting units.

7. The image forming apparatus according to claim 1, wherein
the two wireless readers are the same in positions in the longitudinal directions.
